(19) United States
(12) Patent Application Publication
(10) Pub. No.: US 2015/0130421 A1
(43) Pub. Date: May 14, 2015

(54) BATTERY MANAGEMENT ELECTRONICS WITH CONFIGURABLE BATTERY MODULE BYPASS CONTROL

(71) Applicant: John Joseph Bevilacqua, III, Reston, VA (US)

(72) Inventor: John Joseph Bevilacqua, III, Reston, VA (US)

(21) Appl. No.: 14/537,510

(22) Filed: Nov. 10, 2014

Related U.S. Application Data
(60) Provisional application No. 61/902,132, filed on Nov. 8, 2013.

(51) Int. Cl. H02J 7/00

(52) U.S. Cl. CPC H02J 7/0014
USPC 320/122

(57) ABSTRACT

A system that supports multiple battery cell bypass schemes by reconfiguring a set of electronics. This system allows a single circuit to be used either for providing a charge path in a diode/switch battery module bypass scheme or for providing commands to a current-activated bypass switch used for electrically removing a battery module from a stack of cells. The subject system utilizes a single circuit design that can service multiple bypass schemes (diode/switch bypass and current activated bypass switches) by reconfiguring the external connections between the battery management electronics and the battery cell bypass devices.

### CROSS-REFERENCE TO RELATED APPLICATION

This application claims the priority of applicant's U.S. Provisional Application Ser. No. 61/902,132 filed on Nov. 8, 2013. The contents of applicant's Provisional Application is hereby incorporated by reference as thought set forth at length.

### BACKGROUND OF THE INVENTION

This invention relates to the control of different types of electrical bypass devices for bypassing and isolating a defective module in a battery pack or stack.

A typical battery, sometimes referred to as a battery stack, is comprised of a number of series connected battery modules, each comprised of one or many series and/or parallel connected electrochemical battery cells having positive and negative terminals. A battery is generally designed to operate within a set of nominal conditions, including power, voltage, current, and temperature ranges. When one of the modules of the battery becomes defective as a result of ageing of particular battery cell(s), external damage, or use outside the intended conditions, it may exhibit abnormal characteristics including increased internal resistance, degraded capacity, or open circuit. A single cell having these characteristics may cause the battery pack in which it resides to become non-operational, even if the other modules in the pack are fully functioning and have sufficient capacity to allow the battery pack to continue working in a slightly degraded operating mode. For applications in which high reliability is critical, isolating the defective module is a necessity. The act of isolating the defective module is often referred to as module bypassing.

Module bypassing may be accomplished with several methods; these methods generally share common features in that some type of mechanical or solid-state switch is used to provide an alternate path around the failed cell so that the battery pack can conduct charge and discharge current without relying on the failed cell. This can be accomplished in several ways including using diodes to provide a high-current discharge path and switches to provide a lower current charge path; using single-use fusible link switches such as current-activated bypass switches, to mechanically re-configure the connections between modules, or reconfiguring the battery power interface electronics to selectively charge/discharge only the undamaged cells. The set of circuits external to the battery that are used to support these functions (as well as others) may be referred to as battery management electronics.

In a diode/switch bypass scheme, a diode is wired in parallel with the battery module such that the cathode is connected to the positive terminal of the module and the anode is connected to the negative terminal of the module. The diode provides a high current discharge path while a switch (sometimes accompanied by a series resistance) is wired in parallel with the diode in order to provide a path for charge current.

In a current-activated bypass switch a single pole, double throw (SPDT) switch is wired such that the pole connects to the terminal of a battery module while the two throws connect to the positive and negative terminals of the next module in the battery stack. In the event of a module or cell failure, a current-activated switch is commanded to commute by an external signal, causing one module to be removed from the battery stack. These switches typically require a current ranging from one to five amperes in order to actuate.

A portion of the electronics associated with each of these two schemes may be separated from the core battery; in the diode/switch scheme, the bypass switch and its control circuits are often housed in a separate box; in the current-activated bypass scheme, the switches used to apply current to the fusible element are typically located separate from the battery pack. These two sets of circuits would usually consist of two distinct designs which are not interchangeable.

In applications in which there is a benefit from being able to utilize off-the-shelf battery packs from multiple sources, there may be instances in which it is necessary to accommodate different bypass mechanisms. This results in the need to provide battery management electronics which meet two different sets of requirements. This may increase the cost of a single design which meets both sets of requirements with two sets of circuits or result in increased the engineering effort in order to support two different product lines (one for each battery design).

### BRIEF SUMMARY OF THE INVENTION

There is a need for a design which can support multiple battery module bypass schemes with a single set of circuits. To achieve this, the invention provides a number of relatively high-current switches which can be configured in either of two ways. The first is to connect an external power source to a number of external switches which reconfigure the connections between the battery modules. In the second configuration, switches are externally wired in parallel to each battery module; in the event of a cell failure, the switch connected across the failed cell can be turned on to provide a charge and/or discharge path.

The subject invention in combination allows a manufacturer to utilize multiple battery pack designs in a system while being significantly less sensitive to the specific bypass mechanism used. This allows a greater freedom to procure off-the-shelf solutions without having additional nonrecurring expenses to design or procure different battery management electronics for each configuration.

### THE DRAWINGS

Other aspects of the present invention will become apparent from the following detailed description of preferred embodiments taken in conjunction with the accompanying drawings wherein:

FIG. 1 is a schematic diagram of a battery stack and battery management electronics utilizing a switch/diode bypass scheme in an un-bypassed state;

FIG. 2 is a schematic diagram of a battery stack and battery management electronics utilizing a switch/diode bypass scheme in a bypassed state;

FIG. 3 is a schematic diagram of a battery stack and battery management electronics utilizing a current-activated bypass switch scheme in an unbypassed state

FIG. 4 is a schematic diagram of a battery stack and battery management electronics utilizing a current-activated bypass switch scheme in a bypassed state

FIG. 5 is a schematic diagram of a battery stack and battery management electronics utilizing a switch/diode scheme wherein a current limiting element is positioned in series with each bypass diode and dual bypass switches are employed in the battery management electronics for fault protection;

FIG. 6 is a schematic diagram of a battery stack and current activated bypass for the battery stack with battery management electronics containing an additional enable switch added for fault protection and current limiting elements in series with the switches used to command the current-activated bypass switches; and

FIG. 7 is a schematic diagram of a battery stack and current activated bypass configuration, similar to FIG. 6, with the addition of second series bypass switch in the battery management electronics for each battery module in the battery stack in order to provide fault protection for a switch failure.

### DETAILED DESCRIPTION

As used in this specification and claims certain terms have the following meaning:
Battery cell—a single battery comprised of a positive and negative terminal.
Battery module—one or more battery cells wired in parallel.
Battery stack—multiple battery modules wired in series.
Module bypassing—a scheme in which a faulty battery module is electrically removed from a battery stack by means such as opening or closing switches between the faulty module and adjacent battery modules, creating a short circuit across the faulty module, etc.
Current-activated bypass switch—is an electro-mechanical device used to modify the electrical configuration of a group of battery cells or modules that changes state in response to the application of an electrical current.
Battery Management Electronics—are a set of circuits used to support battery maintenance operations including, but not limited to, cell or module bypassing.

A key function of battery management electronics is to provide support for bypassing a dysfunctional battery cell. This invention is associated with two ways of providing this bypass function. One system involves diode/switch bypassing—a diode is wired in parallel with a battery module such that a cathode is connected to a positive terminal of the module and an anode is connected to ae negative terminal of the module. The diode provides a high current discharge path. A second system involves current-activated bypass switches where a single pole, double throw (SPDT) switch is wired such that the pole connects to the terminal of a battery module while the two throws connect to the positive and negative terminals of the next module in the battery stack. In the event of a module or cell failure, a current-activated switch is commanded to commute by an external signal, causing the dysfunctional module to be removed from the battery stack. These switches typically require a current ranging from one to five amperes in order to actuate. Each of these bypassing schemes requires circuits that can drive the cost and size of battery management electronics.

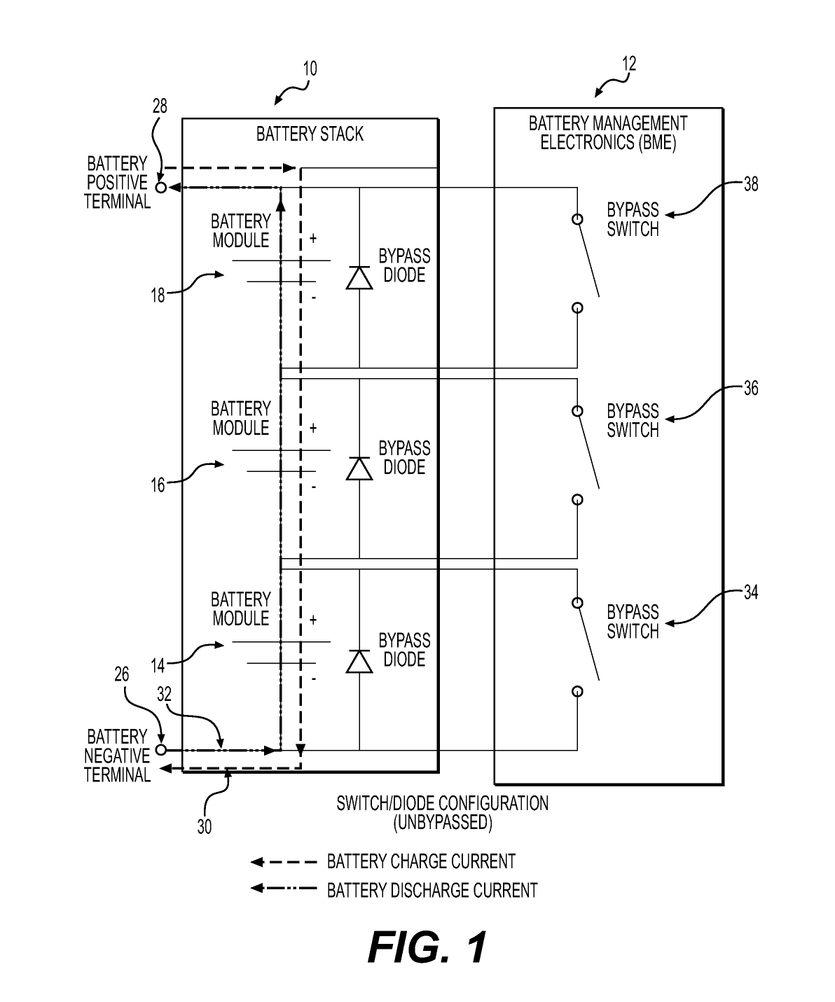

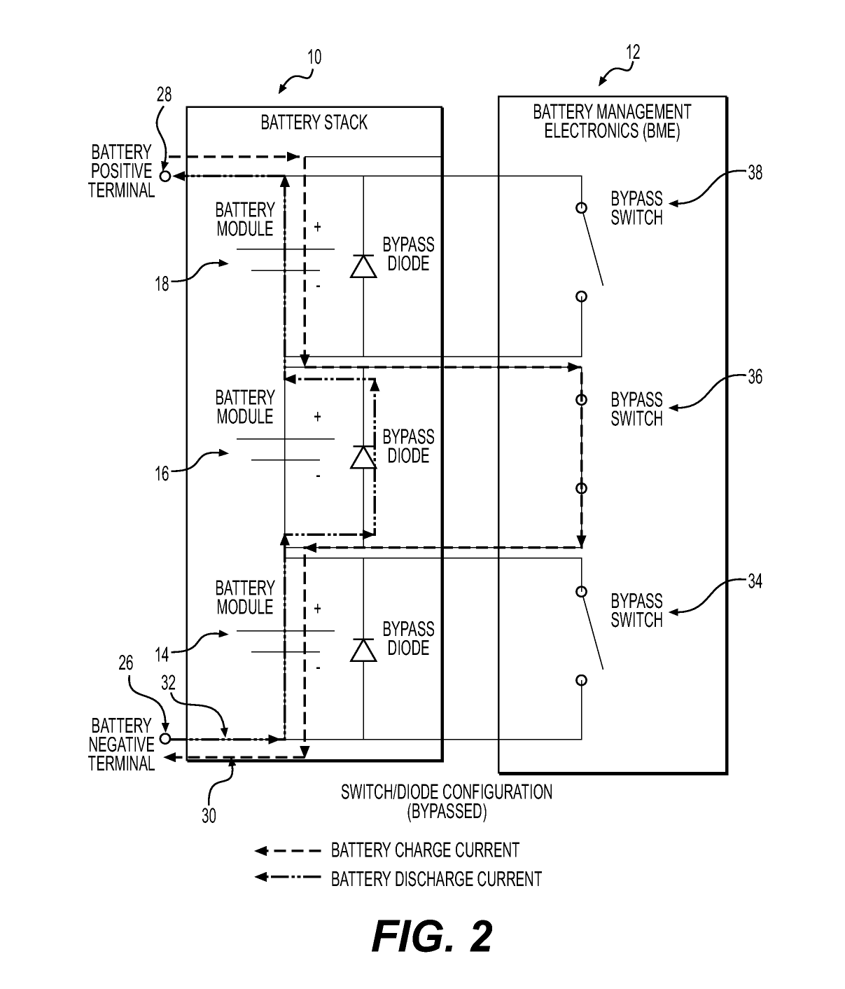

Referring now more particularly to exemplary embodiments of the subject invention depicted in the drawings wherein like reference numerals indicate like parts, FIGS. 1 an 2 disclose schematic diagrams that disclose a nominal battery module stack configuration un-bypassed in FIG. 1 and a bypassed configuration in FIG. 2. Each configuration features a battery stack 10 and battery management electronics 12 that are preferably separated from but operably connected to the battery stack 10.

In the embodiment of the invention depicted in FIGS. 1 and 2 a battery stack configuration of three battery modules 14, 16, and 18 is shown connected in series and compose the representative battery stack 10. Of course, the number of modules in any battery stack can vary with the intended service and function; the three shown is merely representative.

In this embodiment the battery stack 10 is wired with a bypass diode 20, 22 and 24 in parallel with battery modules 14, 16 and 18 respectively. The diodes are shown wired in parallel such that a cathode is connected to a positive terminal of each module and an anode is connected to a negative terminal of each module. The diodes provide a high current discharge path.

In FIGS. 1 and 2 the battery stack 10 is shown having a battery stack negative terminal 26 and a positive stack terminal 28. A battery stack charging path 30 and a discharging current path 32 is depicted in FIG. 1 for a nominal operating system. In FIG. 1 the battery management electronics 12 is not operational (on standby) and by pass switches 34, 36 and 38 are all shown in an open configuration.

In FIG. 2 a failure of the battery 16 is illustrated and battery management electronics 12 has been activated to close bypass switch 36 which in turn redirects charging current through the bypass switch 36 and discharge current 32 passes through the bypass diode 22. This shift actively and effectively takes a faulty battery module 16 out of the operating system.

In brief sum the subject system battery management electronics provides a single bypass switch circuit for each battery module with a separate positive and negative input provided for each module. FIGS. 1 and 2 illustrate charge 26 and discharge 28 current paths for a battery module under both nominal (FIG. 1) and bypassed (FIG. 2) configurations. The parallel diode configuration is unchanged between the two as the diodes 20, 22 and 24 act as uni-directional valves which only allows current to flow when its terminals have a negative voltage between the cathode and anode; a condition which is only present when a parallel battery module has experienced a failure.

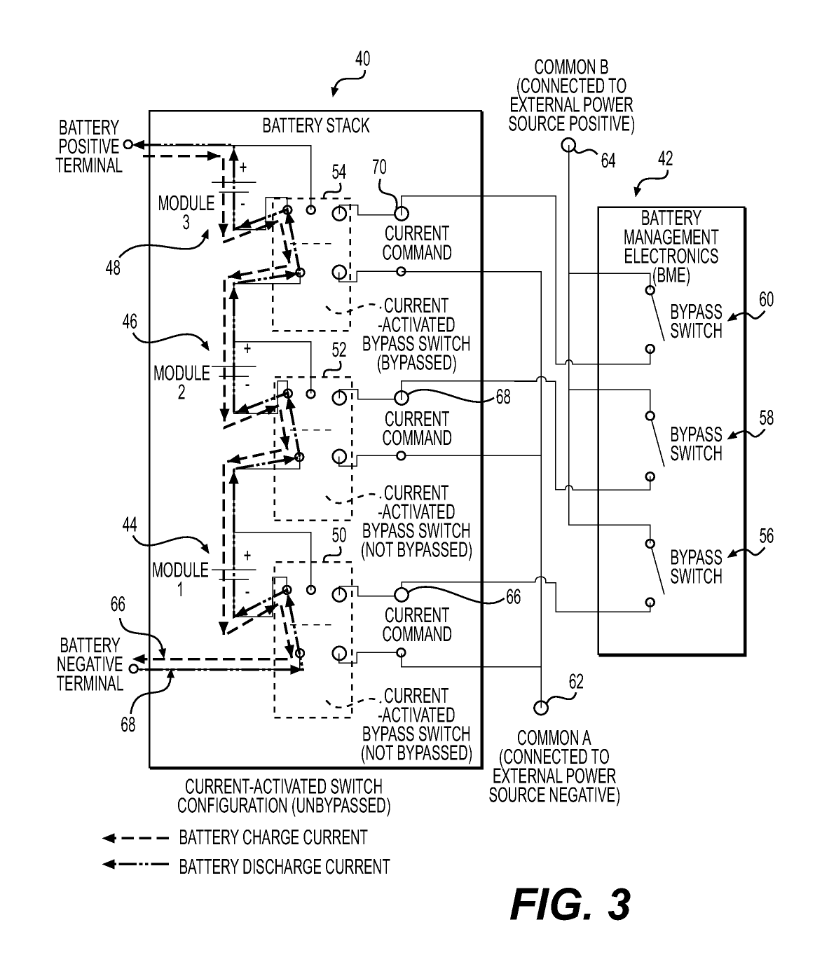

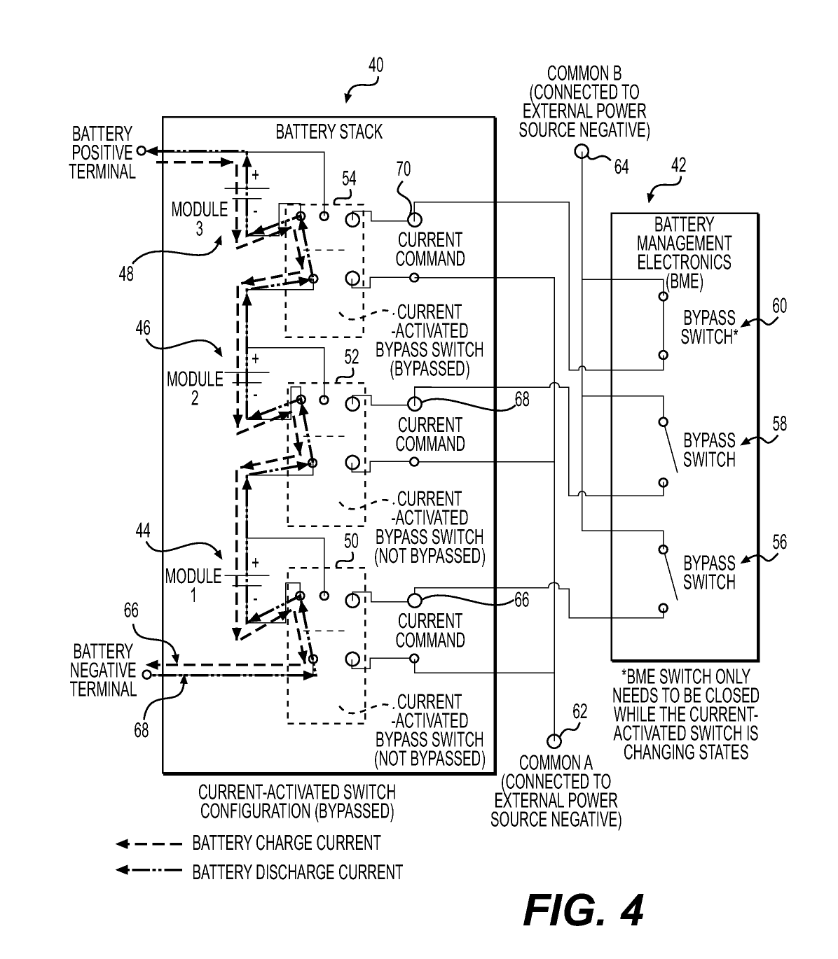

The same switch circuits depicted in FIGS. 1 and 2 may be reconfigured as shown in FIGS. 3 and 4 by modifying the external wiring between the battery management electronics and the battery stack to support commanding current-activated bypass switches. The reconfiguration connects one side of each battery management electronics switch to a single side of a different current-activated switch. The other side of each battery management electronics switch is connected to a common point (Common A). The side of each current-activated switch not connected to the battery management electronics switch is connected to a different common point (Common B). A power source is applied between Common A and Common B. When the battery management electronics switch is activated, this results in a current flowing from the power source, through the battery management electronics switch, across one of the current-activated switches causing the current-activated switch to commute and bypass a single battery cell.

More specifically, FIGS. 3 and 4 disclose a nominal battery stack 40 and a preferably separate but operationally connected battery management electronics 42.

In this embodiment the battery stack 40 is again depicted with an arbitrary, representative, number of battery modules 44, 46 and 48 which may vary with the functional requirements of the system. A current activated bypass switch 50, 52 and 54 is connected in parallel with a corresponding battery module 44, 46 and 48.

The battery management electronics includes a series of bypass switches 56, 58 and 60 which are connected to a common external power source negative 62 and positive 64 terminals. Each of the battery management switches is connect in turn to corresponding current command terminals 66, 68 and 70 of the current activated bypass switches 50, 52 and 54 of the battery stack 40.

FIGS. 3 and 4 illustrates charge 66 and discharge 68 paths for battery current under both nominal and bypassed configurations. In this scheme with the bypass switches being in their nominal position in FIG. 3 none of the battery stack modules are bypassed. In FIG. 4, however, bypass switch 60 is shown in a closed posture and current command is applied to the current activated bypass switch 54 to remove battery module 48 from the battery stack 40. Note that the battery management electronics switch is not used as a charge or discharge path for the battery current in this configuration. Once, the current activated bypass-switch 54 has completed its commutation (an event typically occurring within a second), the bypass switch 60 is no longer required to continue issuing a command and the battery management electronics 42 may return to a standby state with all of its internal switches open.

Further to the above, FIG. 3 discloses a nominal operating condition with charge and discharge current flow 66 and 68 where all of the battery modules 44, 46 and 48 are functioning properly. FIG. 4, however, depicts a current charge 66 and discharge 68 path when battery module 48 is in a fault condition. In this event, bypass switch 60 has been closed commanding the current-activated bypass switch 54 to take the defective battery module 48 off line.

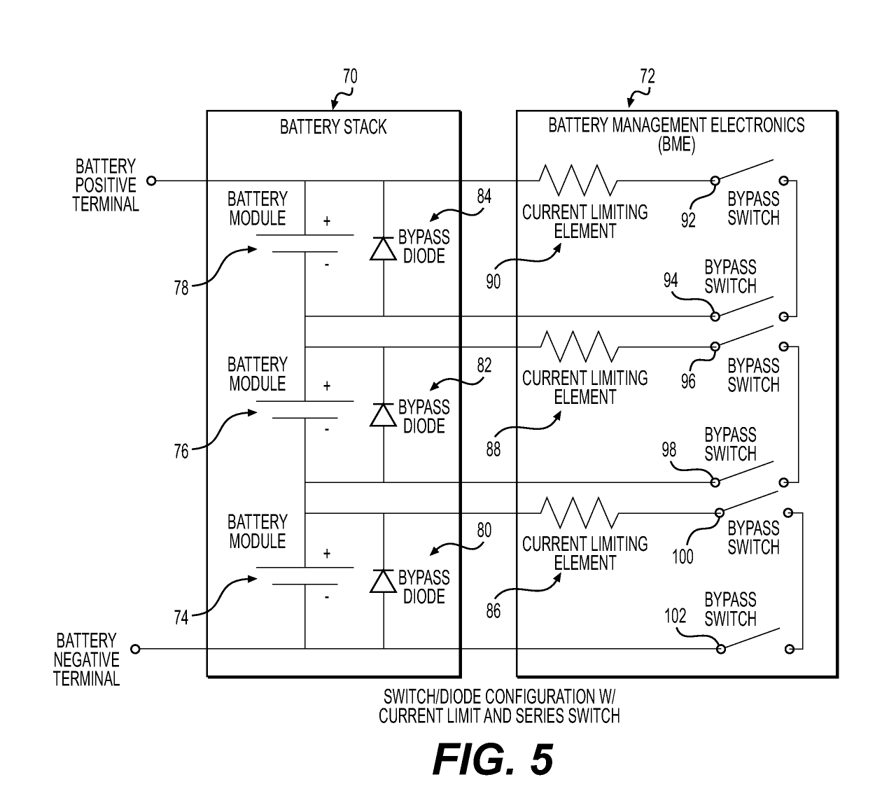

Turning now to FIG. 5 a battery stack 70 and accompanying battery management electronics 72 are shown in a manner and operational function similar to that depicted and described in connection with FIGS. 1 and 2. In this the battery stack is shown composed of an arbitrary sequence of three battery modules 74, 76 and 78 that are fitted with parallel connected bypass diodes 80, 82 and 84. In this embodiment, however, the battery management electronics 72 is fitted with a current limiting element 86, 88 and 90 in series with corresponding bypass switches 92, 94, 96, 98, 100, 102. This current limiting element desensitizes the bypass switches to the voltage of the battery module and will protect the switches from being overstressed if the bypass switch is turned on while the battery module is in a charged state.

In addition to current limiting elements 86, 88 and 90 shown in FIG. 5 the battery management electronics 72 includes pairs of bypass switches 92-94, 96-98 and 100-102 in series with the respective current limiting elements and in parallel with bypass diodes 80, 82 and 84. These series switches 94, 98, 102 provide protection from inadvertently causing a battery cell to become bypassed if there has been a failure of one of the bypass switches 92, 96, 98.

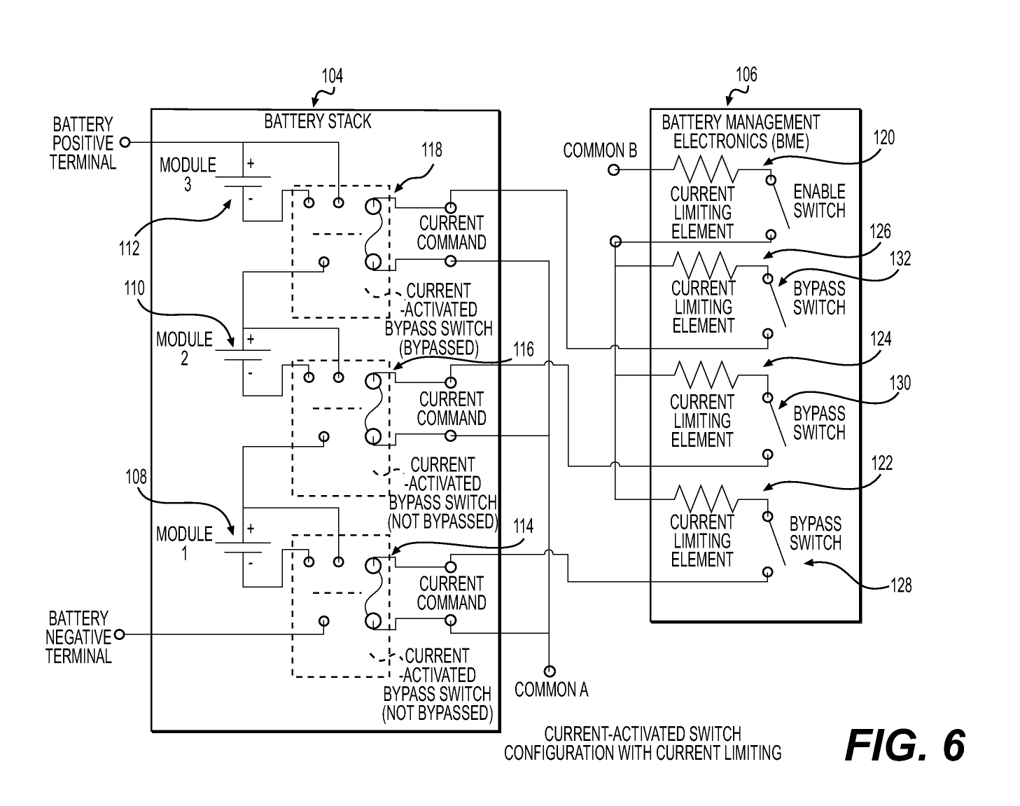

Referring now to FIG. 6 a battery stack 104 and battery management electronics 106 are shown in a manner similar to the drawings and description illustrated in FIGS. 3 and 4. In this embodiment three battery modules 108, 110 and 112 are connected in series to make up the battery stack 104 and a sequence of current activated bypass switches 114, 116 and 118 are connected across the terminals of a respective battery module in a manner as discussed above.

In this embodiment an additional switch 121 may be used in series with Common A or Common B in order to provide tolerance for a failed part or accidental command. A current-limiting element 120 may also be placed in series with Common A or Common B in order to limit the peak current applied to the switched paths as illustrated in FIG. 6. This figure illustrates how a single battery management electronics configuration is able to provide different current limits for the switch/diode configuration shown in FIG. 5. and the current-activated bypass switches 114, 116, 118 shown in FIG. 6. This is accomplished by placing the current limiting element 120 in series with the bypass switches 128, 130, 132 and current limiting elements 122, 124, 126. In this configuration the current limiting element 120 may be used to reduce the maximum current applied to the current-activated bypass switch below the level that would be seen with only the bypass switches 128, 130, 132 and their respective current-limiting elements 122, 124, 126.

The switches used in the battery management electronics 106 may be either mechanical or solid-state. Resistance 122, 124 and 126 may be placed in series with each of the battery management electronics bypass switches 128, 130 and 132 respectively in order to limit the peak current of the switches when used with the diode/switch bypass scheme.

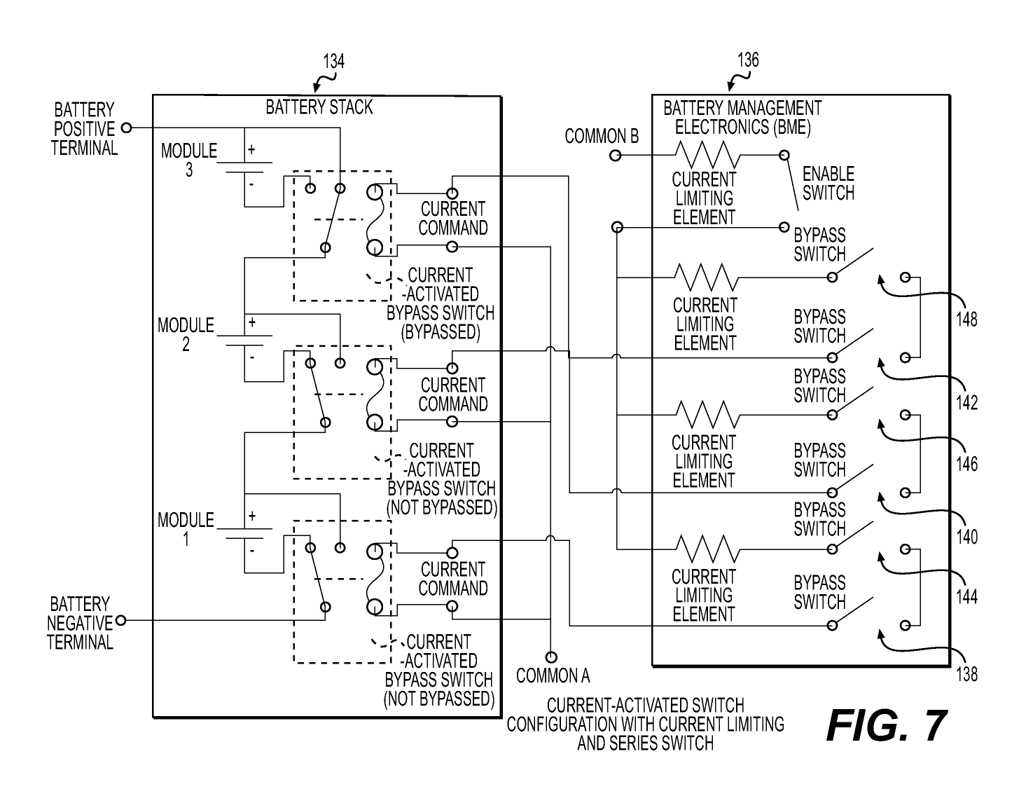

Turning to FIG. 7 a battery stack 134 and associated battery management electronics 136 may utilize a second switch 144, 146 and 148 in series with the initial switch 138, 140, 142 in order to provide fault protection. This figure is a superset of FIG. 5. with the addition of the enable switch and its current limiting element. As connected in FIG. 7, it supports a current-activated bypass scheme; as connected in FIG. 5, it supports a switch/diode scheme. This is done with no change in the internal circuitry of the Battery Management electronics and illustrates how a single design and physical circuit would support both battery module bypass schemes.

Although FIGS. 1-7 have illustrated the subject universal battery module management electronics and battery stack the subject embodiments are meant to be illustrative and not exhaustive The various aspects of the invention were chosen and described in order to best explain principles of the invention and its practical applications. The preceding description is intended to enable those of skill in the art to best utilize the invention in various embodiments and aspects and with modifications as are suited to the particular use contemplated. It is intended that the scope of the invention be defined by the following claims.

What is claimed is:

1. A battery stack and battery management electronics system comprising:
a battery stack including at least two battery modules wherein each of said battery modules are connected in series within the battery stack; and
battery management electronics separated from but connected to said battery stack with a plurality of high-current switches having external connectivity allowing each switch to be either connected in parallel with a battery module for the purpose of providing at least one of a charge and charge/discharge path around a dysfunctional battery module or to control the activation of a current-activated bypass switch.

2. A battery stack and battery management electronics system as defined in claim 1 wherein:
a bypass diode is connected in parallel with each battery module of said battery stack.

3. A battery stack and battery management electronics system as defined in claim 1 wherein:
a current activated bypass switch is connected in between each battery module of said battery stack and such that the switch will route current around one of the modules if commanded to commutate to the alternate position.

4. A battery stack and battery management electronics system as defined in claim 1 wherein:
each of said battery management electronics switches is a solid state switch.

5. A battery stack and battery management electronics system, as defined in claim 1 wherein:
each of said battery management electronics switches are connected in parallel externally to said battery management electronics with a corresponding battery module; and
a current limiting element is connected in series with each of said battery management electronics switches.

6. A battery stack and battery management electronics system, as defined in claim 5 wherein:
each of said battery management electronics switches includes a current limiting element connected in series within the battery management electronics.

7. A battery stack and battery management electronics system as defined in claim 1 wherein:
each of said battery management electronics switches comprises two series switching elements connected in series.

8. A battery stack and battery management electronics system as defined in claim 1 wherein:
each of said battery management electronics switches are connected to an associated current-activated bypass switch external to said battery management electronics; and
a current limiting element is connected in series with each of said battery management electronics switches.

9. A battery stack and battery management electronics system as defined in claim 8 wherein:
each of said battery management electronics switches is comprised of two series switching elements connected in series.

10. A battery stack and battery management electronics system as defined in claim 8 and further comprising:
a single current limiting element connected in series with the all of said current limiting elements and bypass switches of said battery management electronics to provide a lower current limit than that provided by the current limiting element in claim 8

11. A battery stack and battery management electronics system as defined in claim 8 and further comprising:
a single enable switch that is connected in-line with all of the battery management electronics switches defined in claim 1 for the purpose of providing protection from a failure or inadvertent activation of the battery management electronics switches in claim 1.

12. A battery management electronics system comprising:
a plurality of high-current switches having external connectivity allowing each switch to be either connected in parallel with a battery module for the purpose of providing at least one of a charge and charge/discharge path around a dysfunctional battery module or to control the activation of a current-activated bypass switch.

13. A battery management electronics system as defined in claims 12 wherein:
each of said battery management electronics switches is implemented with a solid state switch.

14. A battery management electronics system as defined in claims 12 and wherein:
a current limiting element is connected in series with each of said battery management electronics switches.

15. A battery management electronics system as defined in claims 12 and further comprising:
an enable switch is connected to said bypass switches when battery management electronics switches are configured to command current-activated bypass switches.

16. A battery management electronics system as defined in claims 12 wherein:
a single current limiting element is connected in series with all of said battery management electronics switches to set a current limit to limit the maximum current that is used to command the current-activated bypass switch defined in claim 13.

17. A battery management electronics system as defined in claims 12 wherein:
each of said bypass switches of said battery management electronics comprises two switching elements connected in series.
